(19) United States
(12) Patent Application Publication
(10) Pub. No.: US 2026/0243288 A1
(43) Pub. Date: Aug. 20, 2026

(54) ASSEMBLY ARRANGEMENT

(71) Applicant: Välinge Innovation AB, Viken (SE)

(72) Inventor: Marko SOSTAR, VIKEN (SE)

(73) Assignee: Välinge Innovation AB, Viken (SE)

(21) Appl. No.: 19/543,956

(22) Filed: Feb. 19, 2026

(30) Foreign Application Priority Data
Feb. 20, 2025 (SE) 2550158-6

(51) Int. Cl. F16B 12/24; F16B 12/10; F16B 12/22

(52) U.S. Cl. CPC F16B 12/24; F16B 12/22; F16B 2012/103

(57) ABSTRACT

An assembly arrangement including: a first part having a first abutment surface and a second part having a second abutment surface, wherein the first and second parts are configured to be assembled such that the first and second abutment surfaces abut each other, wherein the assembly arrangement further includes at least two inclined dowels, at least two inclined bores, a male member, and a recess configured to receive the male member, wherein the male member includes a flexible tongue and the recess includes a tongue locking groove, or vice versa, wherein the flexible tongue and the tongue locking groove have a main extension in a direction having a major component along a first direction, and wherein the flexible tongue is insertable into the tongue locking groove for counteracting relative displacement of the first and second parts along a normal direction of the abutment surfaces.

### CROSS REFERENCE TO RELATED APPLICATIONS

The present application claims the benefit of Swedish Application No. 2250158-6, filed on Feb. 20, 2025. The entire contents of Swedish Application No. 2250158-6 are hereby incorporated herein by reference in their entirety.

### TECHNICAL FIELD

The disclosure relates to an assembly arrangement comprising a first part having a first abutment surface, and a second part having a second abutment surface, wherein the first and second parts are configured to be assembled such that the first and the second abutment surfaces abut each other.

### TECHNICAL BACKGROUND

Assembly arrangements for assembling items, such as furniture or furniture components, conventionally include fasteners like screws or nails. However, these fasteners are not always desirable, as they require additional holes in the product and may leave unsightly visible screw or nail heads. Furthermore, mechanical fasteners often require specific tools, adding complexity to the assembly process.

Given these drawbacks, there is a desire for assembly arrangements that eliminate the use of screws and nails.

Conventional assembly arrangements are typically lacking along various dimensions. For example, they tend to be difficult to understand and require many assembly steps. Moreover, they tend to lack strength and the ability to withstand the loads acting thereon. Additionally, upon disassembly, they tend to be prone to damage to the parts or components.

Moreover, the final form and utility of the product (e.g., furniture), tend to set limitations concerning, e.g., available space and load directions.

In WO2012/154113 there is disclosed an assembly arrangement comprising a first and a second element connected perpendicular to each other by the means of a flexible tongue arranged on one element and cooperating with a tongue groove of the other element. The assembly arrangement further comprises a plug protruding perpendicularly from a surface of one of the elements.

In WO2015/038059 there is disclosed an assembly arrangement of an assembled product. The assembly arrangement comprises a first and a second element connected perpendicular to each other by the means of a flexible tongue arranged on one element and cooperating with a tongue groove of the other element.

In WO2024/019644 there is disclosed a joinery product comprising two parts being interconnected by a mechanical locking device including at least two dowels protruding at an angle from a first part and at least two insertion recesses in the second part, the insertion recesses being configured to receive the dowels. The mechanical locking device further includes a compressible locking element which in the uncompressed state partially protrudes from the first part and is configured to be received in a locking recess.

However, there is still a need for an assembly arrangement adequately addressing at least some of the design criteria mentioned above.

### SUMMARY

It is an object of the disclosure to address one or more of the design criteria related to facilitating assembly, providing a strong structure, and facilitating disassembly.

This object has been achieved by an assembly arrangement comprising:
a first part having a first abutment surface, and
a second part having a second abutment surface, wherein the first and second parts are configured to be assembled such that the first and second abutment surfaces abut each other,
wherein the assembly arrangement further comprises
at least two dowels protruding at an inclined protrusion angle from the first or the second abutment surface and being positioned at a mutual distance from each other along a first direction, and
at least two bores extending at an inclined insertion angle into the second or the first abutment surface,
wherein the dowels are configured to be inserted into the bores by an inclined relative motion between the first and second parts and wherein, when the dowels have been inserted into the bores, displacement along a normal direction of the abutment surfaces is counteracted,
wherein the assembly arrangement further comprises
a male member protruding from one of the first and second abutment surfaces, and a recess extending into the other of the first and second abutment surfaces, the recess being configured to receive the male member,
wherein the male member comprises or supports a flexible tongue and said recess comprises a tongue locking groove, or the male member comprises a tongue groove and the recess comprises or supports a flexible tongue, wherein the flexible tongue and the tongue locking groove have a main extension in a direction having a major component along the first direction, and
wherein the flexible tongue is insertable, across an interface between the male member and the recess, and into the tongue locking groove for counteracting relative displacement of the first and second parts along a normal direction of the abutment surfaces when the first and second abutment surfaces abut each other.

By including at least two dowels which protrude at an angle from the first or second abutment surface, the at least two dowels provide load bearing capabilities and counteracts displacement in the normal direction of the abutment surfaces. The at least two dowels also prevent rotation of the first and second parts in relation to each other in a plane parallel to the abutment surfaces, by providing two attachment points spatially separate from each other as seen in said plane.

The dowels may comprise a wood-based material, such as made of solid wood, or may comprise a thermoplastic material.

The first part and/or the second part may be formed by mechanical cutting, such as milling.

The first part and/or the second part may comprise a wood-based material, such as plywood, particle board, HDF board, MDF board, or solid wood.

Compared to a dowel being perpendicular to the abutment surface, a dowel protruding at an inclined protrusion angle, i.e., protruding at an angle distinctly less than 90°, will prevent displacement in the normal direction of the abutment surfaces, which is not prevented by a perpendicularly arranged dowel, and will prevent pure sliding along the first direction. The only direction by which the interaction between the parts may be released is by an inclined translational movement. The interaction between the inclined dowels and the inclined bores will counteract any other kind of movement.

Additionally, the flexible tongue, comprised or supported by the male member or recess and extending into the tongue locking groove of the other of the recess and the male member, counteracts relative displacement of the first and second parts along a normal direction of the abutment surfaces. As a result, both the at least two dowels and the flexible tongue counteract relative displacement of the first and second parts along a normal direction of the abutment surfaces and are thereby both are capable of bearing a load in the normal direction of the abutment surfaces.

Additionally, when the flexible tongue has been inserted into the tongue locking groove and since any initial movement induced to separate the two parts will be due to the inclined dowels and bores result in an inclined relative motion between the first and second parts, a friction is generated between the flexible tongue and the tongue locking groove. Since any inclined displacement will cause the male member to start to move out of the recess and thereby reduce the available space for the flexible tongue, the friction will increase and thereby the displacement of the first and second parts will be counteracted by a friction directed opposite the first direction. This friction counteracting movement of the first and second parts in the first direction will thereby aid in preventing the dowels to be disengaged from its respective bore.

Thus, the provision and orientation of the flexible tongue in combination with the provision and orientation of the inclined dowels and insertion recesses of the assembly arrangement result in an assembly arrangement where the locking effect of the two locking mechanisms have a mutual positive impact on each other, thereby resulting in a strong assembly arrangement.

In view of the above, the assembly arrangement is advantageous as it provides for an easy assembly, while providing a strong locking effect and is capable of bearing load in multiple directions.

An advantage of the present disclosure is that the design and placement of the different features of the assembly arrangement permits the assembly arrangement to be made relatively thin. As an example, the flexible tongue is preferably elongated. The elongated shape of the flexible tongue requires less installation space compared to other types of locking means, such as round or semi-round.

To provide a robust flexible tongue, one variable to consider is the length of the flexible tongue, where the length of the flexible tongue is measured along the main extension of the flexible tongue, which as indicated above extends in a direction having a major component along the first direction. When considering the shear forces on the flexible tongue, the effective area will be the thickness of the tongue times the length of the tongue, where the effective thickness is basically determined by the width of the grooves. Moreover, as the friction and thereby the forces acting on the flexible tongue will increase along with the displacement of the first and second parts the first direction, the length of the flexible tongue affects the load distribution. Put in other words, an elongated flexible tongue is advantageous in that it may exert a pressure distributed over a larger surface or distributed over a larger longitudinal extent of the tongue locking groove. Thus, the use of an elongated flexible tongue locking allows for a strong locking effect with comparably low extension of the male member in the normal direction of the abutment surface and thereby facilitates provision of an improved locking effect compared to single point locking methods, or locking methods not having as large longitudinal extents, and especially in relation to the required extension in the normal direction.

The use of a flexible tongue is advantageous in that it facilitates provision of a maintained locking effect over time.

The length of the flexible tongue may be in the range of 20-200 mm, preferably 30-100 mm. Preferably, these lengths are formed by a single flexible tongue. Especially, the portion extending across the interface between the first and second parts is preferably formed of a single continuous portion of said length. For lengths of the groove exceeding 200 mm it is preferred that several tongues are arranged one after the other in the groove. However, the tongue may be divided into shorter portions, and that this division is especially useful for resiliently flexible portions inside a groove in the male member or in the recess. Thus, the tongue may be designed with a single continuous portion extending across the interface having the lengths discussed above connected to a plurality of shorter resiliently flexible portions.

The length of the flexible tongue may be substantially equal to, or smaller, than a length of the tongue locking groove. It is also conceivable to have a plurality of shorter flexible tongues adding up to a length substantially equal to, or smaller, than the length of the tongue locking groove. However, it is preferred that for lengths of the tongue locking groove being within the above discussed preferred lengths of the flexible tongue, there is a single flexible tongue across the interface; possibly with said shorter resiliently flexible portions.

To join the first and second parts of the assembly arrangement, the respective dowel is aligned or positioned in register with its respective bore. Thereafter, the respective dowel is inserted into the respective bore by an inclined relative motion between the first and second parts. The male member is preferably inserted into the recess about simultaneously as the respective dowels are inserted into the respective bore. The exact timing of the dowels first entering into the bores or the male member first entering the recess is not considered critical. The dowels and/or the bores, typically the dowels, have chamfered or rounded edges to facilitate initial assembly. The male member and/or the recess may have chamfered or rounded edges to facilitate initial assembly. However, irrespective of the initial timing, it is preferred that the dowels have entered into the bores such that the contact between the dowels and bores is capable of guiding the inclined relative motion before the flexible tongue enters into contact with the other part.

It may in this context be noted that it is preferred that there is provided a respective flexible tongue on two opposing sides of the male member, where the two opposing sides extends along said main extension and at a mutual distance from each other in a direction orthogonal to said main extension.

The flexible tongue and tongue groove preferably extend, as seen in a cross-sectional view along the main extension, at an angle relative to a normal direction of the first and second abutment surfaces, the angle preferably being between 15° and 75°.

In this cross-sectional view, the abutment surfaces will typically move to and from each other along the normal direction and some deviation from the normal direction is preferred to provide an extension across the interface and some deviation from a direction orthogonal to the normal direction is preferred to allow the insertion of the male member into the recess to automatically compress the flexible tongue to allow the male member to be positioned into the recess.

The tongue locking groove preferably has an extension being parallel with the first direction. In this context, the first direction may be defined as a distance between a first set of one or more dowels and a second set of one or more dowels. It is, e.g., conceivable to have a first set of two dowels beyond one end of the male member and a second set of, e.g., one dowel beyond the other end of the male member. The first direction is in that case preferably defined as a line between the common center point of the two dowels of the first set to the center point of the dowel of the second set.

The tongue locking groove may have an extension that is angled relative to the first direction, e.g., as seen in a plane defined by the normal direction of the abutment surfaces and the first direction. In such an embodiment, the angle is preferably less than the protrusion angle of the dowels such that flexible tongue may pass from no contact to being fully inserted into the locking tongue groove while the dowels are guided by the bores by being partly to fully inserted into the bores.

The flexible tongue may be formed in a side surface of the male member or the recess. The tongue locking groove may be formed in a side surface of the recess or the male member.

The side surface of the male member may refer to a peripheral surface extending with a height substantially along the normal direction of the first abutment surface. The side surface may be inclined but has preferably at least a major component along the normal direction. Preferably, the side surface is orthogonal to the first abutment surface or alternatively deviating an angle less than 10° from orthogonal.

The side surface of the recess may refer to a peripheral surface extending with a depth substantially parallel to the normal direction of the second abutment surface. The side surface may be inclined but has preferably at least a major component along the normal direction. Preferably, the side surface is orthogonal to the second abutment surface or alternatively deviating an angle less than 10° from orthogonal.

The male member may, e.g., have a tapered extension protruding from one of the first and second abutment surfaces. In such an embodiment, the recess may have a corresponding shape.

The side surface of the male member and recess is preferably configured to face each other when the male member is inserted into the recess.

The side surface of the first and recess may abut each other when the male member is inserted into the recess.

The height of the male member may be substantially equal to, or smaller, than the depth of the recess. Preferably, the height is marginally smaller than the depth of the recess, such that there is a small gap between the top surface of the male member and the bottom surface of the recess. Thereby, the position of the male member in the recess will be defined by the flexible tongue extending across the interface.

The flexible tongue may be separately formed and may be configured to be inserted into a tongue receiving groove formed in a side surface of the male member or in a side surface of the recess. The flexible tongue may be configured to in a locked mode extend out of the receiving groove and into the locking groove to thereby counteract relative displacement of the first and second parts along a normal direction of the first and second abutment surfaces. The flexible tongue may be configured to be resiliently and at least partly movable further into the receiving groove into an insertion mode to allow the male member to enter into the recess when the dowels are inserted into the bores by the inclined relative motion between the first and second parts.

The flexible tongue is transferred to its insertion mode when the flexible tongue is compressed.

The flexible tongue is in its “locked mode” when there is no, or a relatively small, compressive forces acting on the flexible tongue.

The tongue receiving groove may comprise a side surface, an opposite side surface, and a bottom surface extending between the side surface and the opposite side surface.

The flexible tongue may be configured to be compressed towards the bottom surface of the receiving groove.

The flexible tongue may be configured to be compressed towards the bottom surface of the receiving groove during assembling of the first part to the second part.

It is preferred that the flexible tongue is held in position solely by the design of the tongue receiving groove and the locking groove. This may, e.g., be in the form of a frictional engagement and/or by one or both of the grooves having a neck portion such that the flexible tongue is configured to be pressed into said groove through the neck portion or even slid into said groove along the main extension of the groove. The flexible tongue may, however, alternatively or complementary thereto be fixed into the tongue receiving groove by the use of an adhesive.

The friction connection and/or groove with a neck portion may be supplemented a protrusion arranged at the upper surface and/or at the lower surface of the tongue.

To facilitate inserting the male member into the recess, the flexible tongue and/or the part with the tongue locking groove may comprise a cam shaped surface configured to force the flexible tongue away from the tongue locking groove during initial insertion of the male member into the recess. Alternatively expressed, the cam shaped surface may be configured to force the flexible tongue further into the receiving groove.

The at least two dowels may protrude, respectively, from the first or second abutment surface. That is, one or more dowels may protrude from the first abutment surface and one or more dowels may protrude from the second abutment surface. In such an embodiment, a respective bore for each dowel is extending into the other abutment surface.

However, it is preferred that all dowels are protruding from either the first or the second abutment surface, and that the other surface comprises a respective bore for each dowel.

All the dowels are preferably arranged in substantially the same inclined direction, i.e., point in the same inclined direction. In case there are dowels on both parts, the dowels may be considered to point in different directions, but they are preferably all substantially parallel to the same inclined direction.

The protrusion angle may be in a range of 20°-75°, preferably in a range of 35°-55°, relative to the first or second abutment surface from which said dowel protrudes.

The insertion angle may be in a range of 20°-75°, preferably in a range of 35°-55°, relative to the first and second abutment surfaces into which the bore extends.

The protrusion angle of each dowel of the assembly arrangement may be substantially the same.

The term “substantially” refers to that small variations within the manufacturing tolerances are allowable.

In some cases, it might be desired to have small variations between the protrusion angles as this will affect the movement of the first and second parts in relation to each other. It is to be understood that the above is equally applicable in relation to the insertion angle. Such small variations may, e.g., result in that one of the dowels will interact more forcefully with an inside surface of its associated bore compared to the other set or sets of dowel and bore.

Each dowel counteracts displacement of the first part relative to the second part along the normal direction of the first and second abutment surfaces. Put differently, each inclined dowel presses or at least holds the parts together. Thus, positioning a dowel close to an edge of the first or second abutment surface may prevent a gap from appearing. Such a gap could emerge as a consequence of an exterior force.

One or more of the at least two dowels may be placed less than 125 mm, such as less than 75 mm, such as less than 50 mm from any edge of the first or second abutment surface. The edge may be any edge of the first or second abutment surface but is typically the side edge closest to the dowel which is inclined away from, or towards, the same side edge. The position of the dowel may be measured as the distance between the center line of the dowel that is inclined away from, or towards, the side edge. On the other hand, positioning a dowel or a bore close to an edge of the first or second abutment surface may cause the edge to split open. Thus, there is preferably a distance of at least 3 mm between the edge and the portion of the embedded dowel or the portion of the bore being closest to the edge.

The dowels are preferably arranged symmetrically with respect to the main extension of the flexible tongue. Thereby, the forces from the interaction between the different sets of a dowel and a bore will provide a symmetric load onto the flexible tongues and the flexible tongues. The flexible tongues are preferably arranged symmetrically with respect to the positioning of the dowels and bores. Thereby, the forces from the flexible tongues will provide a symmetric load onto the different sets of dowel and bore.

Some of the at least two dowels may be linearly aligning. Alternatively, or additionally, some of the at least two dowels may be distributed on the first or the second abutment surface.

The at least two bores may be through-going holes, but are preferably blind holes, i.e., holes or bores that has a bottom, such as drilled blind holes.

The protrusion angle and the insertion angle may be substantially the same. A difference between the protrusion angle and the insertion angle may be in a range of 0° to 6°, preferably in a range of 1° to 5, wherein preferably the insertion angle is greater than the protrusion angle.

The flexible tongue may be resilient such that when the first and second parts have been assembled, the flexible tongue is configured to be brought into a release mode by forcing the flexible tongue away from the tongue locking groove by at least one release tool to allow the male member to exit out of the recess. The release tool may be designed to partly of fully occupy a space occupied by the flexible tongue inside the tongue locking groove. In this context, it is conceivable to use the release tool also during assembly of the two parts such that the flexible tongue is maintained in an insertion mode until the release tool has been removed.

The at least one release tool may be configured to be inserted through a respective release hole of the assembly arrangement to bring the flexible tongue into the release mode. The hole is preferably provided in the part comprising the tongue locking groove. Thereby, the release tool may remain in position in the release hole and be removed together with the part.

The release hole may be arranged such that the release tool, when inserted therethrough, is arranged to extend along the extension of the tongue locking groove or intersect the extension of the tongue locking groove. Thereby, the release tool may essentially fully take the space otherwise occupied by the flexible tongue inside the tongue locking groove, at least essentially fully as seen in along the main extension.

The release tool may be any elongated element which fits into the release hole. Preferably, the release tool is a specific tool designed and provided for this purpose. However, it is conceivable that the release hole is designed to receive any kind of rod-like member of a diameter slightly smaller than the diameter of the release hole.

The flexible tongue in the insertion mode, and preferably also in a release mode, may be configured to be substantially accommodated within the tongue receiving groove. Thereby, the flexible tongue will fully or at least substantially be removed from the interface where the flexible tongue in locking mode will extend from the tongue receiving groove to the tongue locking groove.

The tongue receiving groove may comprise a side surface, an opposite side surface, and a bottom surface extending between the side surface and the opposite side surface.

The flexible tongue in the insertion mode, and preferably also in a release mode, may be configured to be compressed towards the bottom surface of the receiving groove.

The flexible tongue may comprise a polymer material, such as a thermoplastic material. The flexible tongue may comprise any flexible and resilient material.

An extension of the male member in the first direction and an extension of the recess in the first direction may be substantially the same.

The male member may have an extension in the first direction being at least 60%, preferably at least 70%, more preferably at least 80% of an extension of the recess in the first direction.

The first part may be a panel, or may at least locally be panel-shaped, and the second part may be a panel, or may at least locally be panel-shaped, and wherein the abutment surfaces each form part of, or are parallel to, a respective major surface of the respective panel, or of the panel-shape of the respective first and second parts.

The assembly arrangement may be part of a joinery product, preferably a furniture product. The assembly arrangement may be part of a furniture product such as a chair, a shelf, a dresser, a table, a bed, or any other type of furniture.

All references to “a/an/the [element, device, component, means, step, etc.]” are to be interpreted openly as referring to at least one instance of said element, device, component, means, step, etc., unless explicitly stated otherwise. The steps of any method disclosed herein do not have to be performed in the exact order disclosed, unless explicitly stated or unless it is clear from the technical context that a specific order is necessary.

The disclosure may also in short be said to relate to
an assembly arrangement comprising: a first part having a first abutment surface, and a second part having a second abutment surface, wherein the first and second parts are configured to be assembled such that the first and second abutment surfaces abut each other, wherein the assembly arrangement further comprises at least two inclined dowels, at least two inclined bores, a male member, and a recess configured to receive the male member, wherein the male member comprises or supports a flexible tongue and said recess comprises a tongue locking groove, or vice versa, wherein the flexible tongue and the tongue locking groove have a main extension in a direction having a major component along a first direction, and wherein the flexible tongue is insertable, across an interface between the male member and the recess, and into the tongue locking groove for counteracting relative displacement of the first and second parts along a normal direction of the abutment surfaces when the first and second abutment surfaces abut each other.

### BRIEF DESCRIPTION OF THE DRAWINGS

The disclosure will by way of example be described in more detail with reference to the appended schematic drawings, which shows a presently preferred embodiment of the disclosure.

FIG. 1 shows an exemplary furniture product assembled by the assembly arrangement.

FIG. 2 shows an exploded view of the furniture product as shown in FIG. 1.

FIGS. 3a-3c show a schematic perspective view, a first cross-sectional view, and a second cross-sectional view, respectively, of an exemplary first part of the assembly arrangement.

FIGS. 3d-3f show a schematic perspective view, a first cross-sectional view, and a second cross-sectional view, respectively, of an exemplary second part of the assembly arrangement.

FIG. 4a shows a schematic perspective view of an exemplary arrangement of the first part and a flexible tongue configured to be arranged in a tongue receiving groove.

FIG. 4b shows a schematic perspective view of an exemplary release tool.

FIG. 5 shows a cross-sectional view of an exemplary assembly arrangement in an assembled state.

FIGS. 6a-6f show alternative exemplary arrangements of dowels.

### DETAILED DESCRIPTION OF PREFERRED EMBODIMENTS

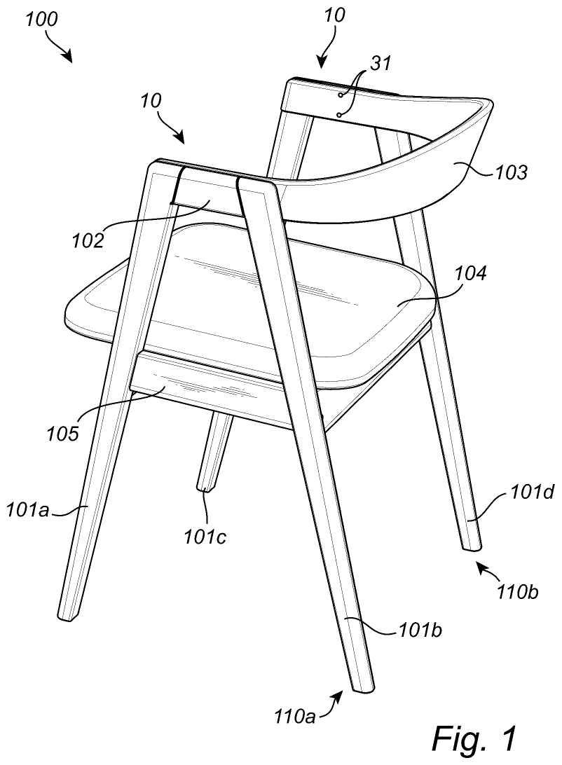

A furniture product 100 comprising an assembly arrangement 10 is shown in FIG. 1. The furniture product 100 is a chair 100 which has been assembled by the use of the assembly arrangement 10 of the present disclosure. In this embodiment, the assembly arrangement 10 is located at the upper parts of the chair 100 and interconnects the legs 101a-d, armrests 102, and backrest 103 of the chair 100. In other embodiments, the assembly arrangement 10 may be used to interconnect other parts of the chair 100 or other types of furniture products.

As shown in FIG. 1, the chair 100 also comprises a seat 104 and leg supports 105. The leg supports 105 are configured to be connected to a respective leg 101a-d at each distal end thereof and to the seat 104.

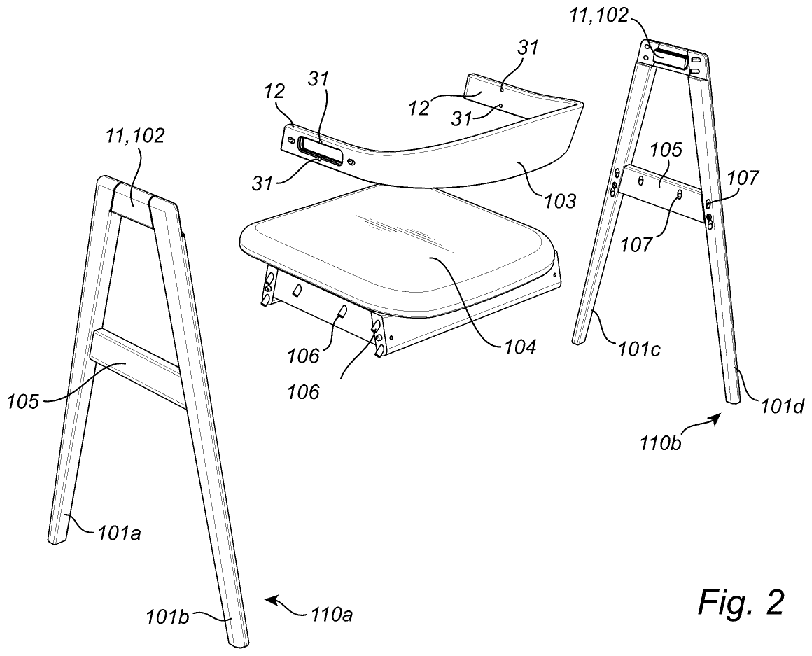

As shown in FIG. 2, respective leg arrangements 110a-b each comprise two of the legs 101a-d, an armrest 102, and a leg support 105. Two such leg arrangements 110a-b are connected to the backrest 103 and the seat 104, as shown in FIG. 1, to provide the assembled chair 100.

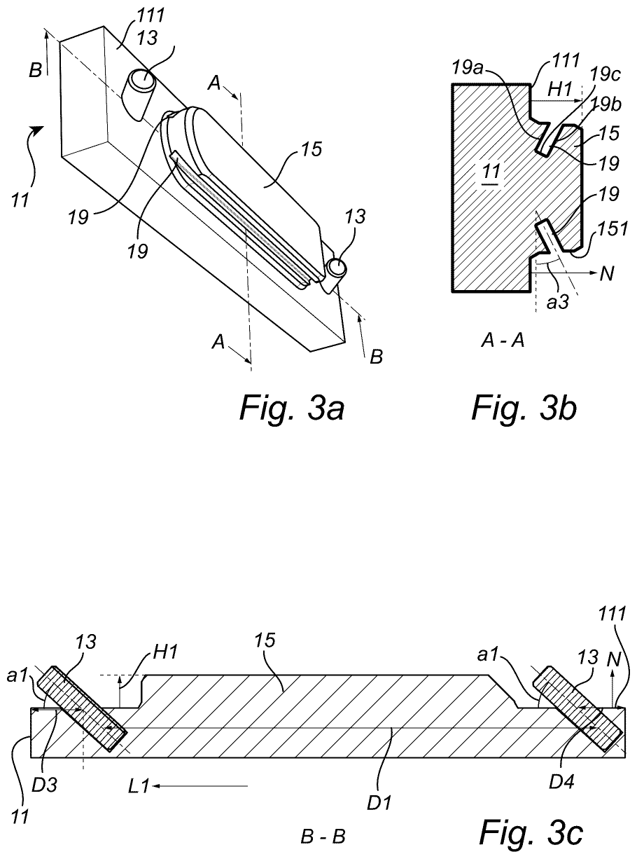

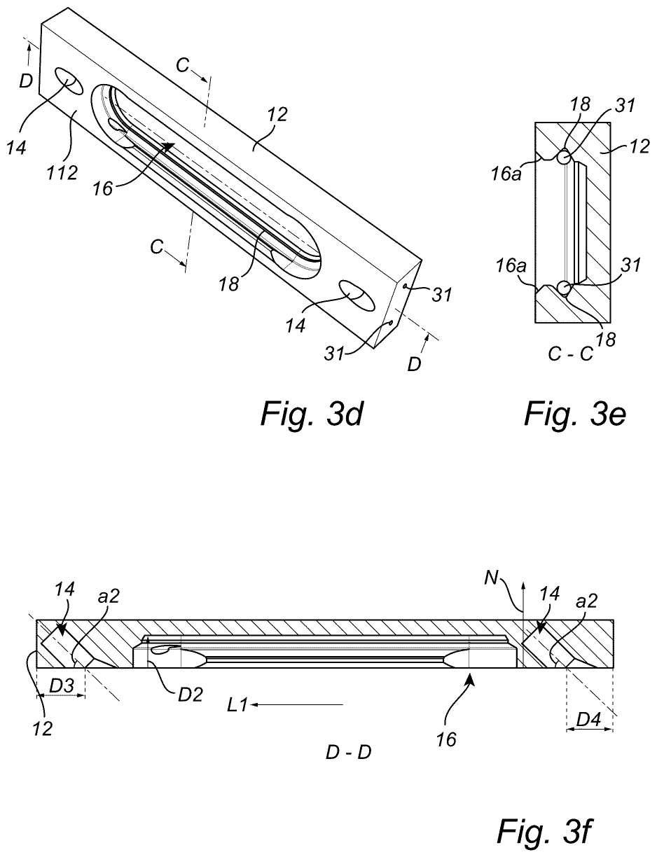

As further shown in FIG. 2, a respective first part 11 of the assembly arrangement 10 is formed by the armrest 102 and a respective end portion of the two legs 101a-d of respective leg arrangement 110a-b. However, as will be shown in conjunction with FIGS. 3a-d, the first part 11 of the assembly arrangement 10 may be formed by one single part of the furniture product 100. A respective second part 12 of the assembly arrangement 10 is formed in a respective side of the backrest 103 of the chair 100. The first and second parts 11, 12 are designed and are configured to be assembled as an assembly arrangement as disclosed herein. The seat 104 comprises a plurality of dowels 106 configured to be inserted into bores 107 of the leg arrangement 110a-b. Alternatively, the leg arrangement 110a-b may include dowels 106 configured to be inserted to bores of the seat 104.

With reference to FIGS. 3a and 3b, the first part 11 is shown in detail. The first part 11 comprises a first abutment surface 111 and two dowels 13. The dowels are configured to be inserted into a respective inclined bore 14 of the second part 12, shown in FIGS. 3d and 3f, by an inclined relative motion between the first and second parts 11, 12. Alternatively, the first part 11 may comprise a first abutment surface 111 and two inclined bores configured to receive respective dowels of the second part 12, by an inclined relative motion between the first and second parts 11, 12. When the dowels 13 have been inserted into the bores 14, displacement along a normal direction N of the abutment surfaces 111, 112 is counteracted.

In FIGS. 3a and 3c, the two dowels 13 protrude at a protrusion angle a1 from the first abutment surface 111 and are positioned at a mutual distance D1 from each other along a first direction L1, as shown in FIG. 3c (showing a distance D1 measured from the center lines of the dowels 13).

The dowels 13 may comprise wood-based material, such as made of solid wood, or may comprise a thermoplastic material.

The first part 11 and/or the second part 12 may be formed by mechanical cutting, such as milling.

The first part 11 and/or the second part 12 may comprise a wood-based material, such as plywood, particle board, HDF board, MDF board, or solid wood.

By including at least two dowels 13 which protrude at an angle a1 from the first abutment surface 111 and by inserting them into a respective inclined bore 14, the at least two dowels 13 provide load bearing and counteracts displacement in the normal direction N of the abutment surfaces 111, 112. The at least two dowels 13 also prevent rotation of the first and second parts 11, 12 in relation to each other in the plane of the abutment surfaces 111, 112, by providing two attachment points spatially separate from each other.

Compared to a dowel being perpendicular to the abutment surface 111, a dowel 13 being arranged with an angle less than 90° relative the abutment surface 111 will prevent displacement both in the normal direction N of the abutment surfaces 111, 112, which is not prevented by a perpendicularly arranged dowel, and sliding along the first direction L1.

The protrusion angle a1 may be in a range of 20°-75°, preferably in a range of 35°-55°, relative to the first abutment surface 111 from which said dowel 13 protrudes. The protrusion angle a1 of each dowel 13 of the assembly arrangement 10 is preferably substantially the same.

Each dowel 13 counteracts displacement of the first part 11 relative to the second part 12 along the normal direction N of the first and second abutment surfaces 111, 112, i.e., each inclined dowel 13 presses the parts together. Thus, positioning a dowel 13 close to an edge of the first or second abutment surface 111, 112 may prevent a gap from appearing. Such a gap could emerge as a consequence of an exterior force. One or more of the at least two dowels 13 may be placed at a distance D3, D4 being less than 125 mm, such as less than 75 mm, such as less than 50 mm from any edge of the first or second abutment surface 111, 112. The edge may be any edge of the first or second abutment surface 111, 112 but is typically the side edge closest to the dowel 13 which is inclined away from, or towards, the same side edge. The position of the dowel 13 may be measured as the distance D3, D4 between the center line of the dowel 13 that is inclined away from, or towards, the side edge. The distance D3 from one dowel 13 to the side edge may be the same or be different from the distance D4 extending between another dowel 13 and the side edge, as seen in FIGS. 3c and 3f. Moreover, the distances D3 and D4 are preferably each at least 3 mm. In FIG. 3c, the distances D3 and D4 are measured from the center lines of the dowels 13.

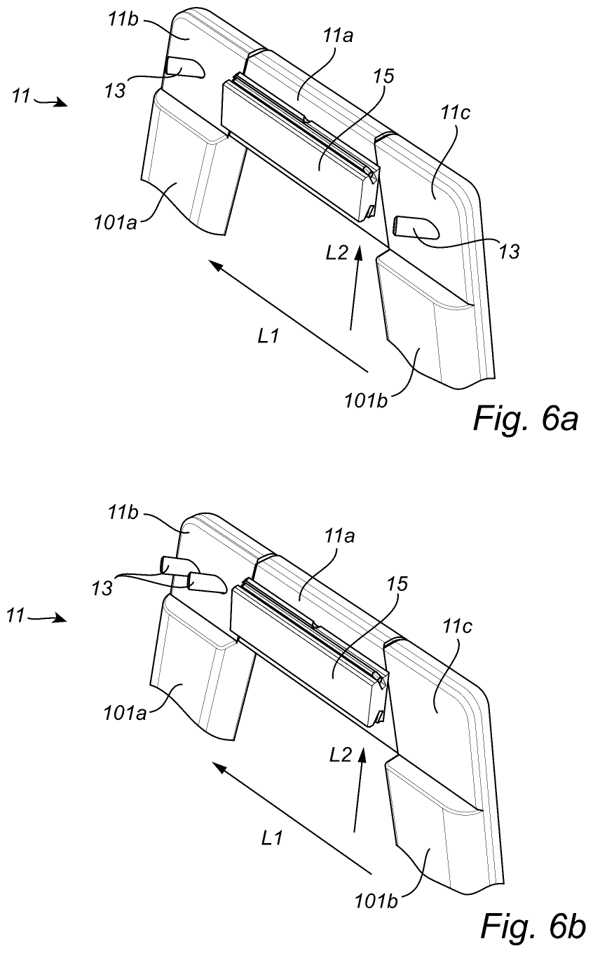

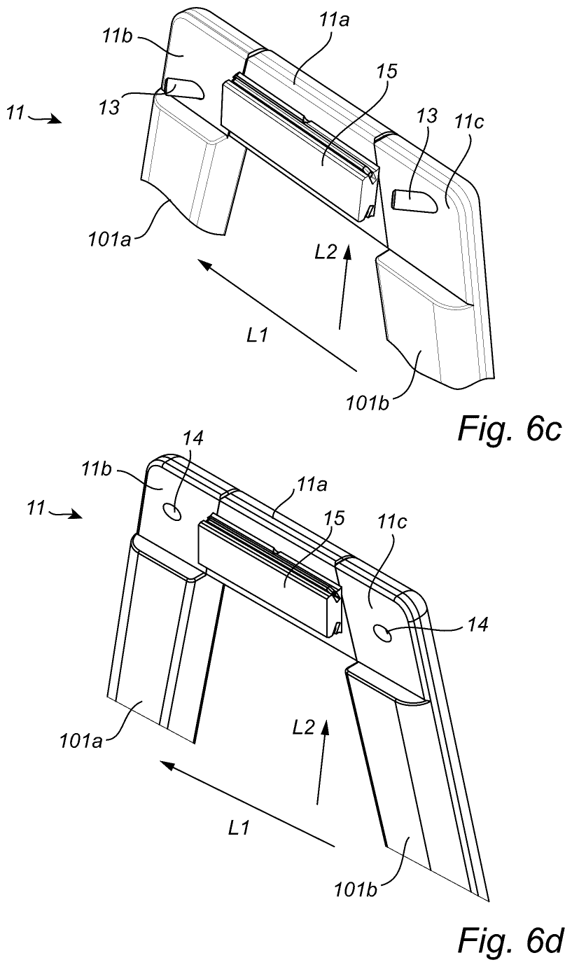

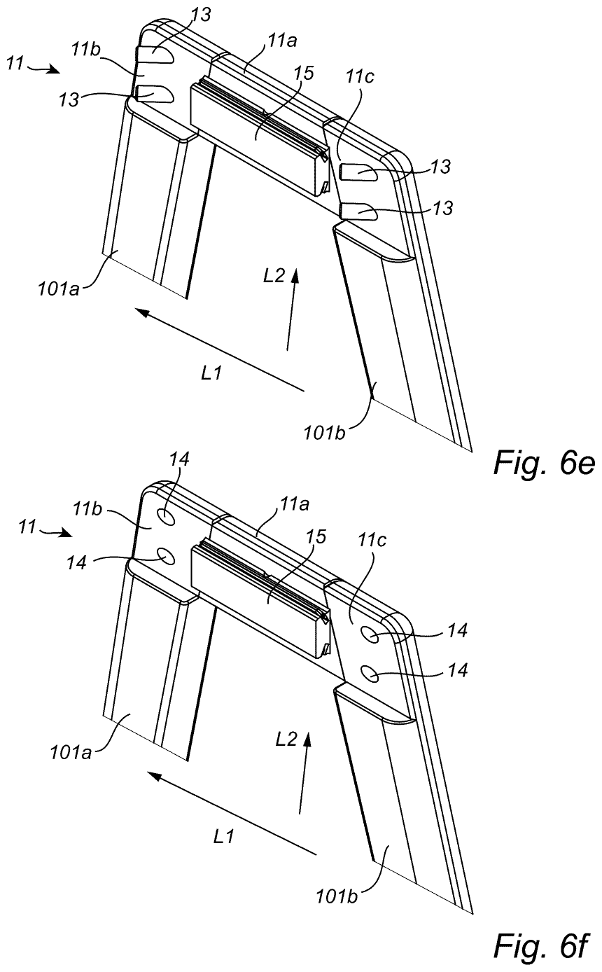

The dowels 13, as shown in FIGS. 3a and 3c, are aligned along a symmetry line of the assembly arrangement. However, as will be discussed with reference to FIGS. 6a-c, the dowels 13 may have different placements, e.g., asymmetric relative to a central line of the assembly arrangement.

The first part 11 comprises a male member 15 protruding from the first abutment surface 111. As seen in FIG. 3a, the two dowels 13 are arranged beyond and at a respective distance from a respective end of the male member 15 as seen along the first direction L1 such that the male member 15 is located between the two dowels 13. As best shown in cross-section A-A in FIG. 3b, the male member 15 comprises two tongue receiving grooves 19 formed in a respective side surface 151 of the male member 15. The side surface 151 is a peripheral surface extending with a height H1 perpendicular to the first abutment surface 111.

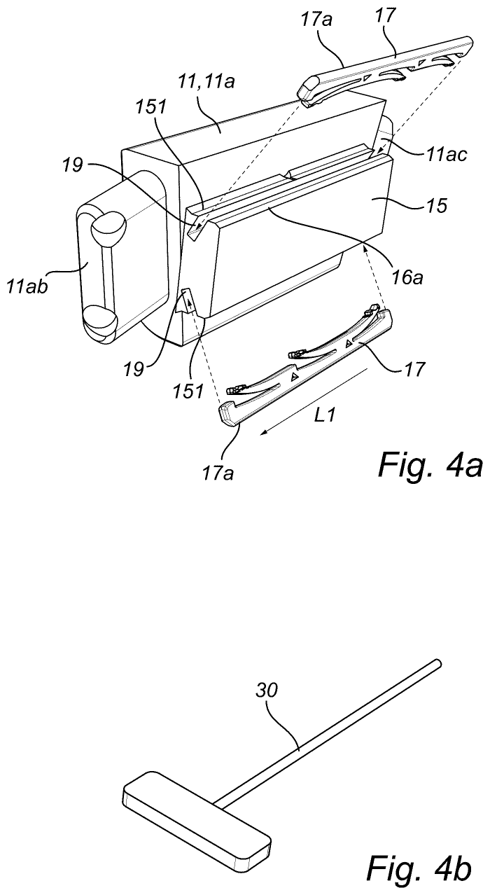

The tongue receiving grooves 19 are configured to receive at least one flexible tongue 17, as will be described in further detail with reference to FIG. 4a. The tongue receiving grooves 19 extend along the main extension of the male member 15. The tongue receiving groove 19 comprise a side surface 19a, an opposite side surface 19b, and a bottom surface 19c extending between the side surface 19a and the opposite side surface 19b.

As shown in FIG. 3b, the tongue receiving grooves 19 are formed with an angle a3 relative to a normal direction N of the first abutment surface 111, the angle preferably being between 15° and 75°.

With reference to FIGS. 3d-3f, the second part 12 is illustrated in more detail. The second part 12 has a second abutment surface 112, wherein the first and second parts 11, 12 are configured to be assembled such that the first and second abutment surfaces 111, 112 abut each other. The second part 12 further comprises two bores 14 extending at an insertion angle a2 into the second abutment surface 112. The insertion angle a2 may be in a range of 20°-75°, preferably in a range of 35°-55°, relative to the second abutment surface 112. The protrusion angle a1 and the insertion angle a2 may be substantially the same, or there may be a difference between the protrusion angle a1 and the insertion angle a2. The difference may be in a range of 0° to 6°, preferably in a range of 1° to 5°, wherein preferably the insertion angle a2 is greater than the protrusion angle a1, e.g., to provide a greater locking strength.

The at least two bores 14 may be holes, such as blind holes. The bores may, e.g., be drilled blind holes.

A recess 16 extends into the second abutment surface 112 and is configured to receive the male member 15 of the first part 11. The recess 16 comprises two opposing tongue locking grooves 18 formed in a respective side surface of the recess 16. The side surface of the recess 16 may refer to a peripheral surface extending with a depth D2 perpendicular to the second abutment surface 112. The side surface of the male member 15 and recess 16 is facing each other when the male member 15 is inserted into the recess 16. The height H1 of the male member 15 is marginally smaller than the depth D2 of the recess 16. For example, the height H1 may be at least 10% smaller than the depth D2, more preferably 5% smaller than the depth D2, and more preferably 1% smaller than the depth D2.

As seen in FIGS. 3a-3c, an extension of the male member 15 in the first direction L1 and an extension of the recess 16 in the first direction L1 are substantially the same.

Alternatively, the male member 15 may have an extension in the first direction L1 being at least 60%, preferably at least 70%, more preferably at least 80% of an extension of the recess 16 in the first direction L1. The male member 15 is however slightly shorter than the recess 16 such that the male member 15 may be partly inserted into the recess 16 and still be moved in the inclined relative motion imparted by the dowels 13 and bores 14. For example, the male member 15 may be at least 1% shorter than the recess 16, more preferably 5% shorter than the recess 16, and more preferably 10% shorter than the recess 16.

With reference to FIG. 4a, an alternative embodiment of the first part 11 is shown. In this embodiment, the first part 11 is formed by three separate parts as was briefly indicated with reference to FIG. 1. The first part 11 comprises one middle portion 11a, as shown in FIG. 4a, and two end portions 11b, 11c, as shown in FIGS. 6a-c. However, unless explicitly referred to as a difference, the disclosure referring to a first part 11 is equally applicable, regardless of how many separate parts that together form the first part 11 of the assembly arrangement 10.

With reference to FIG. 4a, the flexible tongue 17 is shown. The flexible tongue 17 is separately formed and is configured to be inserted into the tongue receiving groove 19 formed in the side surface 151 of the male member 15. In another embodiment, the flexible tongue 17 may form part of the male member 15 or the recess 16, by protruding from the side surface of the male member 15 or the recess 16.

The flexible tongue may be retained in the tongue receiving groove 19 with a friction connection. The friction connection may comprise a protrusion arranged at the upper surface and/or at the lower surface of the tongue. Additionally, or alternatively, the flexible tongue 17 may be fixed in the tongue receiving groove 19 by the use of an adhesive.

When the flexible tongue 17 has been inserted into the tongue receiving groove 19, a portion of the flexible tongue 17 protrudes out of the tongue receiving groove 19 such that there is a protruding lip extending along the main extension of the flexible tongue 17. The flexible tongue 17 is resilient such that, when the flexible tongue is compressed, the flexible tongue 17 is at least substantially accommodated within the tongue receiving groove 19.

In one embodiment, only one flexible tongue 17 is arranged in the male member 15, or the recess 16. Alternatively, two or more flexible tongues 17 may be arranged in the male member 15 or the recess 16. Each flexible tongue 17 may be arranged in a respective tongue receiving groove 19, or several flexible tongues 17 may be arranged one after the other in the same tongue receiving groove 19. In the preferred embodiment, there are two sets of flexible tongues 17, one on each side of the male member 15. Each such set preferably includes one flexible tongue 17, but may include two or more flexible tongues 17 arranged one after the other in a single groove, or each arranged in a respective groove, or distributed in a number of grooves.

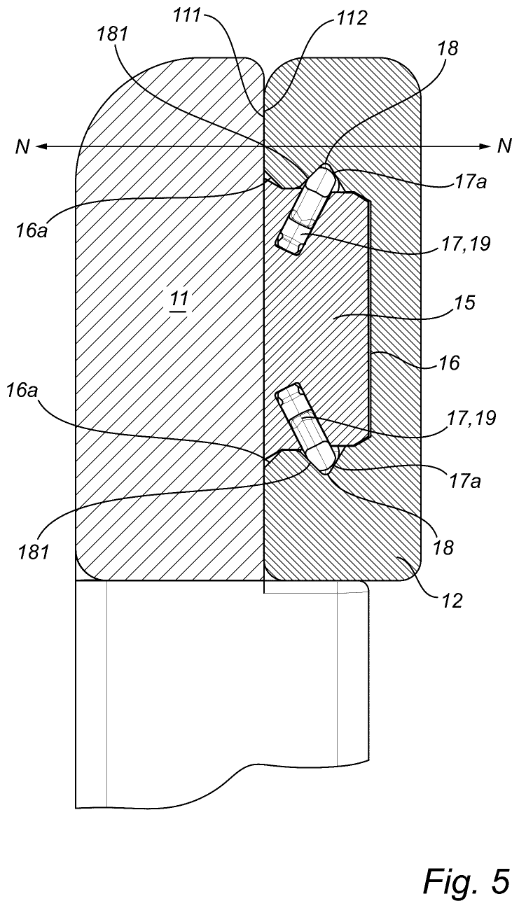

To facilitate inserting the male member 15 into the recess 16, the flexible tongue 17 may comprise a cam shaped surface 17a configured to force the flexible tongue 17 away from the tongue locking groove 18 during initial insertion of the male member 15 into the recess 16. The cam shaped surface 17a extends along the main extension of the flexible tongue 17. In the preferred embodiment, there is formed a continuous cam shaped surface 17a, but it is conceivable to design the cam shaped surface 17a as an intermittent surface distributed along the main extension as long as it is capable of providing a cam functionality over a sufficient fraction of the length of the flexible tongue 17. In the preferred embodiment, the cam surface 17a is provided by shaping the elongated top surface rounded. The rounded shape refers to the shape as shown in a cross-section across the main extension, such as, e.g., shown in FIG. 5. The cam shaped surface 17a is formed at least on the side, side as seen in said cross-section, of the flexible tongue 17 that will be the leading side in the contact with the part provided with the tongue locking groove 18. The cam shaped surface 17a may have other shapes, such as a chamfer, a combination of chamfer and rounded shape, etc. In the preferred embodiment, the flexible tongue 17 is provided in a tongue receiving groove 19 and the action of the cam surface 17a to force the flexible tongue 17 away from the tongue locking groove 18 is in practice an action of forcing the flexible tongue 17 to a greater extent into the tongue receiving groove 19. Additionally, or alternatively, the recess 16 may comprise a cam shaped surface 16a located between the tongue locking groove 18 and the abutment surface of the part provided with the recess 16. The comments concerning the design and function of the cam surface 17a of the flexible tongue 17 are equally applicable to the cam surface 16a of the recess 16.

As shown in FIG. 4a, the tongue locking groove 18 has an extension that is parallel with the first direction L1. In an alternative embodiment, the tongue locking groove 18 may have an extension that is slightly (non-zero) angled relative to the first direction L1. This non-zero angle may be such that the tongue locking groove 18 forms a slope angle relative to the abutment surfaces. In such an embodiment, the angle is preferably less than the protrusion angle a1 of the dowel 13.

With reference to FIG. 5, the first part 11 and the second part 12 of the assembly arrangement 10 have been assembled such that the first and second abutment surfaces 111, 112 abut each other. The male member 15 has been inserted into the recess 16, and the dowels 13 have been inserted into its respective bore 14, although not shown in this cross-sectional view. The flexible tongue 17, arranged in the tongue receiving groove 19, has been inserted, across an interface between the male member 15 and the recess 16, and into the tongue locking groove 18 for counteracting relative displacement of the first and second parts 11, 12 along a normal direction N of the abutment surfaces 111, 112. Moreover, first and second abutment surfaces 111, 112 may be configured to abut such that, in an assembled position of the first and second parts 11, 12, a separation exists between the bottom of the recess 16 and the outermost surface of the male member 15, as shown in FIG. 5.

The flexible tongue 17 and tongue groove 18 extend, as seen in a cross-sectional view along the main extension, at an angle relative to the normal direction N of the first and second abutment surfaces 111, 112, the angle preferably being between 15° and 75°.

The flexible tongue 17 is configured to in a locked mode extend out of the receiving groove 19 and into the tongue locking groove 18 to thereby counteract relative displacement of the first and second parts 11, 12 along a normal direction N of the first and second abutment surfaces 111, 112, as shown in FIG. 5. As beforementioned, the flexible tongue 17 is configured to be resiliently and at least partly movable further into the receiving groove 19 into an insertion mode to allow the male member 15 to enter into the recess 16 when the dowels 13 are inserted into the bores 14 by the inclined relative motion between the first and second parts 11, 12. The flexible tongue 17 is transferred to its insertion mode when the flexible tongue 17 is compresses.

The flexible tongue 17 is in its “locked mode”, as seen in FIG. 5, when there is no, or a relatively small, compressive forces acting on the flexible tongue 17.

The flexible tongue 17 may be resilient such that when the first and second parts 11, 12 have been assembled, the flexible tongue 17 is configured to be brought into a release mode by forcing the flexible tongue 17 away from the tongue locking groove 18 by at least one release tool 30 to allow the male member 15 to exit out of the recess 16.

As shown in FIG. 4b, the at least one release tool 30 may basically be a rod configured to be inserted through a respective release hole 31 of the assembly arrangement 10 to bring the flexible tongue 17 into the release mode. The release hole 31 may be arranged such that the release tool, when inserted therethrough, is arranged to extend along the extension of the tongue locking groove 18, as shown in FIG. 3d-f, or intersect the extension of the tongue locking groove 18, as shown in FIG. 1-2. In the disclosed embodiments, the active part of the release tool 30 has basically a cylindrical cross-section and the release holes 31 are circular. However, the holes 31 and tools 30 may have other cross-sectional shapes as long as the tool 30 is insertable into the holes 31 and preferably guided by the walls of the holes 31. It is, e.g., conceivable to have the holes 31 in the embodiment of FIG. 1-2 where the holes 31 intersect the extension of the tongue locking groove 18 designed as long holes with the longer extension extending along the main extension of the tongue locking groove 18 such that the release tool 30 may interact with and force away the flexible tongue 17 along a comparably longer distance along the main extension of the tongue looking groove 18. It may also be noted that, e.g., in the embodiment of FIG. 1-2 where the holes 31 intersect the extension of the tongue locking groove 18, there may be a plurality of holes 31 distributed along the main extension of the tongue locking groove 18, such that the flexible tongue 17 may be forced away along a comparably longer distance along the main extension of the tongue looking groove 18. Such a plurality of holes 31 may be configured to receive a plurality of release tools 30 at the same time or one release tool 30 inserted into the respective hole 31 one after the other. In a design with a plurality of holes 31, the release tool 30 may be designed with a plurality of rod-shaped portions connected to a single handle.

The flexible tongue 17 while in the insertion mode, and preferably also in a release mode, may be configured to be substantially accommodated within the tongue receiving groove 19.

The flexible tongue 17 in the insertion mode, and preferably also in a release mode, may be configured to be compressed towards the bottom surface 19c of the receiving groove 19.

When the first and second parts 11, 12 have been assembled, as shown in FIG. 5, the flexible tongues 17, arranged in a respective tongue receiving groove 19, counteract relative displacement of the first and second parts 11, 12 along a normal direction N of the abutment surfaces 111, 112 as they lock into the respective tongue locking groove 18. As a result, both the two dowels 13 and the flexible tongues 17 counteract relative displacement of the first and second parts 11, 12 along a normal direction N of the abutment surfaces 111, 112 and are thereby both capable of bearing a load in the normal direction N of the abutment surfaces 111, 112.

Additionally, when the flexible tongue 17 has been inserted into the tongue locking groove 18 and an inclined relative motion between the first and second parts 11, 12 is induced to separate the two parts, a friction is generated between the flexible tongue 17 and the tongue locking groove 18. The friction will increase quickly along with any tendency of displacement of the first and second parts 11, 12 in the first direction L1, since the angled dowels 13 forces the first and second parts 11, 12 away from each other in an inclined relative motion and the flexible tongue 17 is simultaneously pressed upwardly against a wall 181 of the tongue locking groove 18. This friction will counteract movement of the first and second parts 11, 12 in the first direction L1 and thereby prevents the dowels 13 to be disengaged from its respective bore 14.

Thus, as beforementioned, the flexible tongue and the dowels 13 of the assembly arrangement 10 jointly counteracts relative displacement of the first and second parts along a normal direction N of the abutment surfaces 111, 112, and the flexible tongue 17 counteracts inclined relative motion between the first part 11 and the second part 12 in the first direction L1.

To provide a robust flexible tongue 17, one variable to consider is the length of the flexible tongue 17. As the friction and thereby the forces acting on the flexible tongue 17 will increase along with the displacement of the first and second parts 11, 12 in the first direction L1, the length of the flexible tongue 17 may be important as it affects the load distribution. Put in other words, the flexible tongue 17 may be advantageous in that it may exert a pressure distributed over a larger surface or distributed over a larger longitudinal extent of the tongue locking groove 18. Thus, the locking may be improved compared to single point locking methods, or locking methods not having as large longitudinal extents.

The flexible tongue 17 may be advantageous in that its design may provide a maintained constant locking force over time.

The length of the flexible tongue may be in the range of 20-200 mm, preferably 30-100 mm, for a width of the flexible tongue which may be within a range of 3-10 mm, preferably for a width within a range of 4-7 mm.

The length of the flexible tongue 17 may be substantially equal, or smaller, than the extension of the tongue locking groove 18.

With reference to FIG. 6a-c, different arrangements of the at least two dowels 13 are shown. Even though FIG. 6a-c discloses an assembly arrangement 10 comprising two dowels 13, it is to be understood that the assembly arrangement 10 may comprise more than two dowels 13, such as four dowels as shown in FIG. 6e or only one dowel 13.

With reference to FIG. 6a, the two dowels 13 are linearly aligned and arranged on a respective side of the male member 15.

With reference to FIG. 6b, two dowels 13 are linearly aligned on one side of the male member 15. In this embodiment the dowels 13 are arranged one after the other in the first direction L1, however, in another embodiment the dowels 13 may be arranged one after the other in a second direction L2, with the second direction L2 being angled to or preferably perpendicular to the first direction L1. In another embodiment, the assembly arrangement 10 may comprise two or more dowels 13 on each side of the male member 15, or the recess 16, wherein the dowels may be arranged one after the other in the first and/or second direction L1, L2. In one embodiment, there is no dowel 13 on the other side of the male member 15, or the recess 16. It is also conceivable to have only one dowel 13 on only one side of the male member 15, or recess 16. In yet another embodiment, there are a plurality, preferably two, dowels 13 on one side of the male member 15, or the recess 16, and one dowel 13 on the other side. The two dowels 13 on one side may be distributed along the first direction L1, or alternatively along the second direction L2, being angled or preferably perpendicular to the first direction L1.

With reference to FIG. 6c, two dowels 13, one on each side are arranged on a respective side of the male member 15 and being linearly offset relative each other.

With reference to FIG. 6d, two bores 14, one on each side are arranged on a respective side of the male member 15.

With reference to FIG. 6e, four dowels 13, two on each side are arranged on a respective side of the male member 15.

With reference to FIG. 6f, four bores 14, two on each side, are arranged on a respective side of the male member 15.

In summary, on any of the sides of the male member 15, or recess 16, there may be none, one, or a plurality of dowels 13 distributed along the first direction L1 and/or along a second direction L2 forming an angle with the first direction L1. Preferably, there is at least one dowel 13 on each side of the male member 15, or recess 16. It may also be noted that for elongated male member 15 and recess 16, the dowels 13 need not be positioned at the respective ends of the male member 15, or recess 16, as disclosed in the figures, but may alternatively or additionally be positioned at a portion at the longer sides of the male member 15, or recess 16.

It is to be noted that the at least two dowels 13 may be protruding, respectively, from the first or second abutment surface 111, 112. Meaning that one or more dowels 13 may be protruding from the first abutment surface 111 and one or more dowels 13 may be protruding from the second abutment surface 112. In such an embodiment, a respective bore 14 for each dowel 13 is extending into the other abutment surface.

Preferably, all dowels 13 are protruding from either the first or the second abutment surface 111, 112, and the other abutment surface comprises at least a respective bore 14 for each dowel 13.

Each dowel 13 is preferably arranged in substantially the same direction, i.e., points in the same direction, as shown in FIGS. 3a, 6a-c, and 6e.

As shown in FIGS. 6a-f, a first portion 11 formed by three separate parts 11a-c is shown. In FIGS. 3a and 3c, the first portion 11 is formed by one single part. The middle part 11a, as shown in FIG. 4a, is in FIG. 6a-c, connected to two end portions 11b, 11c at a respective connection portion 11ab, 11ac thereof. In this embodiment, the middle part 11a is formed by the armrest 102 and the two end portions 11b, 11c are end portions of two respective legs 101a-d of the chair 100, as shown in FIGS. 1-2.

In another embodiment, not shown in any of the drawings, the second part 12 is formed by several connectable separate parts.

Even though it is preferred that the assembly arrangement is designed in accordance with the disclosure in the detailed disclosure of preferred embodiments and the appended drawings, it should be noted that a specific preferred embodiment of a specific component does not necessarily have to be combined with a specific embodiment of another component. Thus, advantages associated with a specific embodiment, including one or more features, of a specific component may be accomplished even though the other components is/are designed in accordance with the more general disclosure under the summary of the disclosure rather than being defined in accordance with the specific embodiment disclosed in the detailed description.

The assembly arrangement may, as an example, be designed with the male member including the tongue locking groove configured to interlock a flexible tongue arranged in the recess and/or optionally also include a flexible tongue configured to be interlocked in a tongue locking groove in the recess.

It is contemplated that there are numerous modifications of the embodiments described herein, which are still within the scope of the claims.

### Items

1. An assembly arrangement (10) comprising:
a first part (11) having a first abutment surface (111), and
a second part (12) having a second abutment surface (112), wherein the first and second parts (11, 12) are configured to be assembled such that the first and second abutment surfaces (111, 112) abut each other,
wherein the assembly arrangement (10) further comprises
at least two dowels (13) protruding at an inclined protrusion angle (a1) from one of the first and second abutment surfaces (111, 112) and being positioned at a mutual distance (D1) from each other as measured along a first direction (L1), the first direction (L1) being parallel with a geometrical projection of the dowels (13) onto said one of the first and second abutment surfaces (111, 112), and
at least two bores (14) extending at an inclined insertion angle (a2) into the other one of the first and second abutment surfaces (111, 112),
wherein the dowels (13) are configured to be inserted into the bores (14) by an inclined relative motion between the first and second parts (11, 12) and wherein, when the dowels (13) have been inserted into the bores (14), displacement along a normal direction (N) of the abutment surfaces (111, 112) is counteracted,
wherein the assembly arrangement (10) further comprises
a male member (15) protruding from one of the first and second abutment surfaces (111, 112), and a recess (16) extending into the other of the first and second abutment surfaces (111, 112), the recess (16) being configured to receive the male member (15),
wherein the male member (15) comprises or supports a flexible tongue (17) and said recess (16) comprises a tongue locking groove (18), or the male member (15) comprises a tongue locking groove (18) and the recess (16) comprises or supports a flexible tongue (17), wherein the flexible tongue (17) and the tongue locking groove (18) have a main extension in a direction having a major component along the first direction (L1), and
wherein the flexible tongue (17) is insertable, across an interface between the male member (15) and the recess (16), and into the tongue locking groove (18) for counteracting relative displacement of the first and second parts (11, 12) along a normal direction (N) of the abutment surfaces (111, 112) when the first and second abutment surfaces (111, 112) abut each other.

2. The assembly arrangement (10) according to item 1, wherein the flexible tongue (17) and tongue locking groove (18) extend, as seen in a cross-sectional view along the main extension, at an angle (a3) relative to a normal direction of the first and second abutment surfaces (111, 112), the angle preferably being between 15° and 75°.

3. The assembly arrangement (10) according to item 1 or 2, wherein the flexible tongue (17) is formed in a side surface of the male member (15) or the recess (16), and the tongue locking groove (18) is formed in a side surface of the recess (16) or the male member (15).

4. The assembly arrangement (10) according to item 1 or 2, wherein the flexible tongue (17) is separately formed and is configured to be inserted into a tongue receiving groove (19) formed in a side surface of the male member (15) or in a side surface of the recess (16), wherein the flexible tongue (17) is configured to, in a locked mode, extend out of the receiving groove (19) and into the tongue locking groove (18) to thereby counteract relative displacement of the first and second parts (11, 12) along a normal direction (N) of the first and second abutment surfaces (111, 112), and wherein the flexible tongue (17) is configured to be resiliently and at least partly movable further into the receiving groove (19) into an insertion mode to allow the male member (15) to enter into the recess (16) when the dowels (13) are inserted into the bores (14) by the inclined relative motion between the first and second parts (11, 12).

5. The assembly arrangement (10) according to any one of items 1 to 4, wherein the flexible tongue (17) and/or the second part comprises a cam shaped surface (171) configured to force the flexible tongue (17) away from the tongue locking groove (18) during initial insertion of the male member (15) into the recess (16).

6. The assembly arrangement (10) according to any one of items 1 to 5, wherein the protrusion angle (a1) is in a range of 20°-75°, preferably in a range of 35°-55°, relative to the first or second abutment surface (111, 112) from which said dowel (13) protrudes.

7. The assembly arrangement (10) according to any one of items 1 to 6, wherein the insertion angle (a2) is in a range of 20°-75°, preferably in a range of 35°-55°, relative to the first and second abutment surfaces (111, 112) into which the bore (14) extends.
8. The assembly arrangement (10) according to any one of items 1 to 7, wherein a difference between the protrusion angle (a1) and the insertion angle (a2) is in a range of 0° to 6°, preferably in a range of 1° to 5, wherein preferably the insertion angle (a2) is greater than the protrusion angle (a1).

9. The assembly arrangement (10) according to any one of items 1 to 8, wherein the flexible tongue (17) is resilient such that when the first and second parts (11, 12) have been assembled, the flexible tongue (17) is configured to be brought into a release mode by forcing the flexible tongue (17) away from the tongue locking groove (18) by at least one release tool to allow the male member (15) to exit out of the recess (16).

10. The assembly arrangement (10) according to item 9, wherein the at least one release tool is configured to be inserted through a respective release hole of the assembly arrangement (10) to bring the flexible tongue (17) into the release mode, wherein the release hole is arranged such that the release tool, when inserted therethrough, is arranged to extend along the extension of the tongue locking groove (18) or intersect the extension of the tongue locking groove (18).

11. The assembly arrangement (10) according to any one of items 1 to 10 including a dependency of item 4, wherein the flexible tongue (17) in the insertion mode, and preferably also in a release mode, is configured to be substantially accommodated within the tongue receiving groove (19).

12. The assembly arrangement (10) according to any one of items 1 to 11, wherein an extension of the male member (15) in the first direction (L1) and an extension of the recess (16) in the first direction (L1) are substantially the same.

13. The assembly arrangement (10) according to any one of items 1-12, wherein the male member (15) has an extension in the first direction (L1) that is at least 60%, preferably at least 70%, more preferably at least 80% of an extension of the recess (16) in the first direction (L1).

14. The assembly arrangement (10) according to any one of items 1 to 13, wherein the flexible tongue (17) comprises a polymer material, such as a thermoplastic material.

15. The assembly arrangement (10) according to any one of items 1 to 14, wherein the first part (11) is at least locally panel-shaped, and the second part (12) is at least locally panel-shaped, and wherein the abutment surfaces (111, 112) each form part of, or are parallel to, a respective major surface of the panel-shape of the respective first and second parts.

16. The assembly arrangement (10) according to any one of items 1 to 15, wherein the assembly arrangement (10) is a part of a joinery product, preferably a furniture product (100).

17. The assembly arrangement (10) according to any one of items 1 to 16, wherein the first and second abutment surfaces (111, 112) are configured to abut such that, in an assembled position of the first and second parts (11, 12), a separation exists between a bottom of the recess (16) and an outermost surface of the male member (15).

18. The assembly arrangement (10) according to any one of items 1 to 17, wherein the tongue locking groove (18) has an extension that is sloped relative to the first direction L1, such that the tongue locking groove (18) and the first and second abutment surfaces (111, 112) form a non-zero angle in an assembled position of the first and second parts (11, 12).

1. An assembly arrangement comprising:
a first part having a first abutment surface, and
a second part having a second abutment surface, wherein the first and second parts, are configured to be assembled such that the first and second abutment surfaces abut each other,
wherein the assembly arrangement further comprises
at least two dowels protruding at an inclined protrusion angle from one of the first and second abutment surfaces and being positioned at a mutual distance from each other as measured along a first direction, the first direction being parallel with a geometrical projection of the dowels onto said one of the first and second abutment surfaces, and
at least two bores extending at an inclined insertion angle into the other one of the first and second abutment surfaces,
wherein the dowels are configured to be inserted into the bores by an inclined relative motion between the first and second parts, and wherein, when the dowels have been inserted into the bores, displacement along a normal direction of the abutment surfaces is counteracted,
wherein the assembly arrangement further comprises
a male member protruding from one of the first and second abutment surfaces, and a recess extending into the other of the first and second abutment surfaces, the recess being configured to receive the male member,
wherein the male member comprises or supports a flexible tongue and said recess comprises a tongue locking groove, or the male member comprises a tongue locking groove and the recess comprises or supports a flexible tongue, wherein the flexible tongue and the tongue locking groove have a main extension in a direction having a major component along the first direction, and
wherein the flexible tongue is insertable, across an interface between the male member and the recess, and into the tongue locking groove for counteracting relative displacement of the first and second parts, along a normal direction of the abutment surfaces when the first and second abutment surfaces abut each other.

2. The assembly arrangement according to claim 1, wherein the flexible tongue and tongue locking groove extend, as seen in a cross-sectional view along the main extension, at an angle relative to a normal direction of the first and second abutment surfaces.

3. The assembly arrangement according to claim 1, wherein the flexible tongue is formed in a side surface of the male member or the recess, and the tongue locking groove is formed in a side surface of the recess or the male member.

4. The assembly arrangement according to claim 1, wherein the flexible tongue is separately formed and is configured to be inserted into a tongue receiving groove formed in a side surface of the male member or in a side surface of the recess, wherein the flexible tongue is configured to, in a locked mode, extend out of the receiving groove and into the tongue locking groove to thereby counteract relative displacement of the first and second parts along a normal direction of the first and second abutment surfaces, and wherein the flexible tongue is configured to be resiliently and at least partly movable further into the receiving groove into an insertion mode to allow the male member to enter into the recess when the dowels are inserted into the bores by the inclined relative motion between the first and second parts.

5. The assembly arrangement according to claim 1, wherein the flexible tongue and/or the second part comprises a cam shaped surface configured to force the flexible tongue away from the tongue locking groove during initial insertion of the male member into the recess.

6. The assembly arrangement according to claim 1, wherein the protrusion angle is in a range of 20°-75°, relative to the first or second abutment surface from which said dowel protrudes.

7. The assembly arrangement according to claim 1, wherein the insertion angle is in a range of 20°-75°, relative to the first and second abutment surfaces, into which the bore extends.

8. The assembly arrangement according to claim 1, wherein a difference between the protrusion angle and the insertion angle is in a range of 0° to 6°.

9. The assembly arrangement according to claim 1, wherein the flexible tongue is resilient such that when the first and second parts have been assembled, the flexible tongue is configured to be brought into a release mode by forcing the flexible tongue away from the tongue locking groove by at least one release tool to allow the male member to exit out of the recess.

10. The assembly arrangement according to claim 9, wherein the at least one release tool is configured to be inserted through a respective release hole of the assembly arrangement to bring the flexible tongue into the release mode, wherein the release hole is arranged such that the release tool, when inserted therethrough, is arranged to extend along the extension of the tongue locking groove or intersect the extension of the tongue locking groove.

11. The assembly arrangement according to claim 4, wherein the flexible tongue in the insertion mode, is configured to be substantially accommodated within the tongue receiving groove.

12. The assembly arrangement according to claim 1, wherein an extension of the male member in the first direction and an extension of the recess in the first direction are substantially the same.

13. The assembly arrangement according to claim 1, wherein the male member has an extension in the first direction that is at least 60% of an extension of the recess in the first direction.

14. The assembly arrangement according to claim 1, wherein the flexible tongue comprises a polymer material.

15. The assembly arrangement according to claim 1, wherein the first part is at least locally panel-shaped, and the second part is at least locally panel-shaped, and wherein the abutment surfaces each form part of, or are parallel to, a respective major surface of the panel-shape of the respective first and second parts.

16. The assembly arrangement according to claim 1, wherein the assembly arrangement is a part of a joinery product.

17. The assembly arrangement according to claim 1, wherein the first and second abutment surfaces are configured to abut such that, in an assembled position of the first and second parts, a separation exists between a bottom of the recess and an outermost surface of the male member.

18. The assembly arrangement according to claim 1, wherein the tongue locking groove has an extension that is sloped relative to the first direction L1, such that the tongue locking groove and the first and second abutment surfaces, form a non-zero angle in an assembled position of the first and second parts.
